(19) United States
(12) Patent Application Publication
(10) Pub. No.: US 2013/0180457 A1
(43) Pub. Date: Jul. 18, 2013

(54) VENTING MEANS

(71) Applicant: Rex Allan PIKE, Masterton (NZ)

(72) Inventor: Rex Allan PIKE, Masterton (NZ)

(73) Assignee: Robert Dymock MCINTYRE, Hunterville (NZ)

(21) Appl. No.: 13/550,111

(22) Filed: Jul. 16, 2012

(30) Foreign Application Priority Data
Jul. 14, 2011 (NZ) 594083
Nov. 23, 2011 (NZ) 596601

(51) Int. Cl. A01K 9/00; A61J 11/02

(52) U.S. Cl. CPC A01K 9/00; A61J 11/02
USPC 119/71; 215/11.5

(57) ABSTRACT

A venting arrangement for a feeding teat closure 10 that can be fitted to or form part of a feeder. The closure 10 includes an opening 12 with which a mounting part of a feeding teat can engage in a substantially sealed manner. The venting arrangement includes at least one aperture 21 in the opening 12 and at least one recess 22 that creates a break in the seal between the teat mounting part and a sealing surface 19 of the opening 12 whereby air can vent through the combination of the break formed by the recess 22 and the aperture(s) 12.

### BACKGROUND OF THE INVENTION

This invention relates to a venting means and more particularly a venting means for a feeder with a feeding teat. It also relates to a teat mounting closure incorporating the venting means.

It is known to mount a feeding teat to a feeder container such as a bottle whereby an animal can suckle the teat and derive a supply of liquid feed from within the bottle. The present invention has been designed primarily for feeders intended for feeding young animals such as calves, lambs, deer etc. Thus for convenience the following description will relate to feeders for the feeding of young animals.

To ensure that the animal can derive a good flow of feed from the bottle it is known to provide some means of venting the interior of the bottle. In this way air can flow into the bottle as liquid feed is drawn out of the bottle. However, venting arrangements can lead to undesired leakage of the liquid feed from the bottle during feeding of the animal. This can result in not only loss of valuable feed but also the creation of a mess.

Also the venting arrangement can become clogged up or not provide an effective vent to cope with the demands of an animal feeding from the bottle. For example the vent may comprise moving parts that cease to operate either fully or partially.

In this specification reference will be made to the animal feeder comprising a bottle. However, it will be appreciated that the invention has application to other forms of animal feeders.

### SUMMARY OF THE INVENTION

An object of the invention is thus to provide a venting means for a feeder with a feeding teat, the venting means being of a simple construction yet be effective in providing a vent for the feeder with no or minimal leakage occurring during feeding of the animal.

Another object of the invention is to provide a teat mounting closure for a feeder, the closure incorporating such a venting means.

Broadly in one aspect of the invention there is provided a venting means for a feeding teat the venting means including an opening with which a mounting part of a feeding teat can engage in a substantially sealed manner, at least one aperture in the opening and at least one recess that creates a break in the seal between the teat mounting part and a sealing surface of the opening whereby air can vent through said break and the aperture(s).

Preferably the recess(es) is(are) located with the sealing surface.

Preferably there is a plurality of apertures.

In a preferred embodiment of the invention the recess is coupled to a single one of the apertures. In another preferred form there is only a single aperture and an associated recess.

In a preferred form the aperture(s) is/are located in a rebate adjacent the opening. A counter bore can form the rebate.

In one form the recess is a slot, groove, channel or the like in the sealing surface and is connected to the aperture.

In the preferred form the dimensions of the recess is selected such as to provide a venting break in the seal between the mounting part of the teat and the opening yet without substantially any leakage of liquid feed through the venting break during feeding of an animal.

In a preferred form the recess is in the form of an open topped slot, channel or groove.

Preferably the at least one protrusion is located in the rebate or counterbore adjacent the opening.

Preferably the protrusion(s) is/are of a height that is less than the depth of the rebate/counterbore.

Preferably the protrusions are offset from the apertures.

Preferably the protrusion is a pad or ridge of a height of substantially between 0.10 and 0.30 mm.

In a second broad aspect there is provided a feeder bottle which has an opening to which is removably fitted a closure, the closure has an opening in which a mounting part of an animal feeding teat and the closure includes a venting arrangement that includes an opening with which, in use, a mounting part of a feeding teat can engage in a substantially sealed manner, at least one aperture in the opening and at least one protrusion and/or recess that creates a break in the seal between the teat mounting part and a sealing surface of the opening whereby air can vent through said break and the aperture(s).

In the preferred form the closure of the feeder bottle is a removable cap.

In a preferred form of the feeder bottle the at least one recess is located with the sealing surface and is coupled to a single one of the apertures.

In the preferred form of the feeder bottle the recess is a slot, groove, channel or the like in the sealing surface and is connected to the aperture.

In the preferred form of the feeder bottle the dimensions of the recess is selected such as to provide a venting break in the seal between the mounting part of the teat and the opening yet without substantially any leakage of liquid feed through the venting break during feeding of an animal.

In the preferred form of the feeder bottle the at least one aperture is located in a rebate adjacent the opening and the rebate is formed by a counter bore.

### BRIEF DESCRIPTION OF THE DRAWINGS

In the following more detailed description of one embodiment of a venting means according the present invention reference will be made to the accompanying drawings showing a closure, in the form of a bottle cap, that incorporates the venting means and in which:

FIG. 1 is an isometric view of a bottle cap incorporating the venting means of the present invention,

FIG. 2 is an elevation view of the bottle cap shown in FIG. 1,

FIG. 3 is an underside plan view of the bottle cap,

FIG. 4 is the detail A of the bottle cap shown in FIG. 1,

FIG. 5 is a top plan view of the bottle cap,

FIG. 6 is a further detail view being a section on line B-B of the bottle cap shown in FIG. 5,

FIG. 7 is an isometric view of a bottle cap incorporating the venting means of the present invention according to a second embodiment, and

FIG. 8 is a part view on an enlarged scale of the bottle cap shown in FIG. 7.

### DESCRIPTION OF PREFERRED EMBODIMENTS OF THE INVENTION

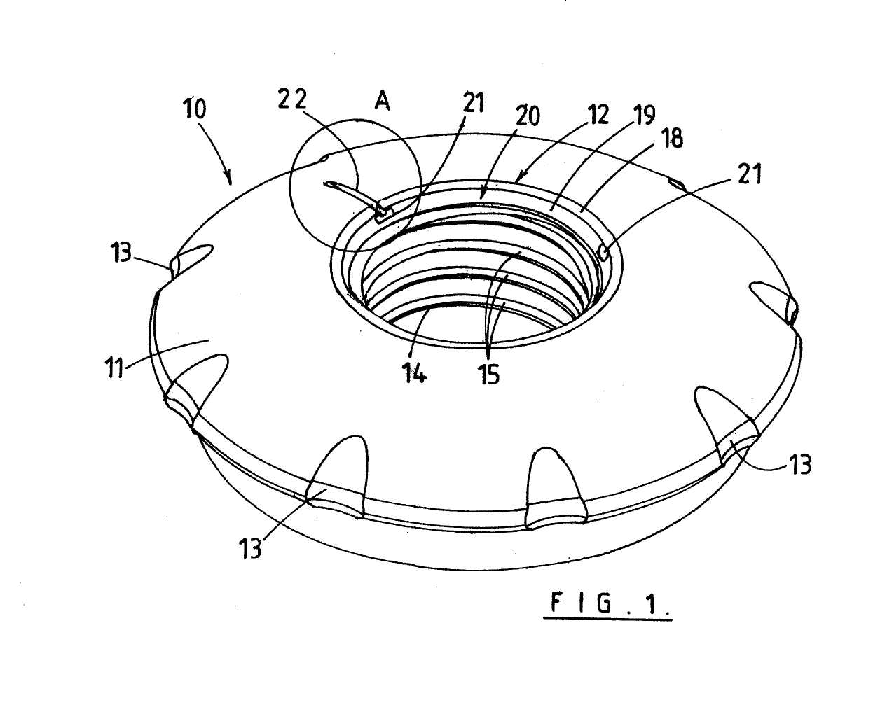

In FIGS. 1 to 6 and 7 to 8 the drawings there are shown embodiments of a venting means incorporating the invention when forming part of teat closure in the form of a bottle cap. It will be appreciated by the skilled addressee that a venting means incorporating the invention can be achieved by way of embodiments, which differ from that which is described and illustrated in the present specification.

Referring firstly to FIGS. 1 to 6 the bottle cap 10 as illustrated in the drawings includes a cover 11 with a central opening 12. Scalloped portions 13 are preferably provided at the peripheral edge of the cover 11 and form hand-gripping areas to facilitate gripping of the cap 10 when screwing the cap 10 onto or off a feeder bottle (not shown).

In the following description the term “top” and “outer surface” in relation to the cap 10 indicate the part of the cover 11 of the cap that is visible in FIG. 1. The “underside” and “interior” or “inside” of the cap 10 are the area of the cap 10 that is visible in FIG. 3.

In the illustrated form of the bottle cap 10 the opening 12 is intended for the mounting of a feeding teat (partially shown in FIG. 6). The opening 12 includes a skirt 14 that has a screw form 15 formed therein. This enables a screw-threaded teat T of the type sold under the trade mark PEACH and described and claimed in New Zealand patent specification No. 504554 to be screwed onto the cap 10. This is achieved by the screw threaded mounting portion M of the teat T being screwed into the threaded skirt 14 so that the teat projects from the outer surface of the cap 10.

It will be appreciated by the skilled person that a screw-threaded skirt 14 is not the only way in which a teat can be connected/mounted to the cap 10. For example the opening 12 will take a different form when the teat to be attached to the cap is of the known pull through type.

Positioned inwardly of the peripheral edge of the cover 11 is a mounting skirt 16. This skirt 16 is concentric with opening 12 and skirt 14. The skirt 16 has a screw thread 17 formed therewith so that the cap 10 can be screwed onto the threaded neck of a bottle. Once again the skilled person will appreciate that the skirt 16 can take different forms e.g. to allow the cap 10 to be snap fitted or interference fitted to the neck of a bottle.

In the preferred form of the cap 10 the cap is moulded in one piece from a suitable plastics material.

The teat to be fitted to the cap 10 will include a flange or shoulder portion F that will engage with the outer surface of the cover 11 in the immediate area of the opening 12. According to the preferred form of the cap 10 an annular rebate such as a shallow counter bore 18 (as illustrated) is provided. The aforesaid flange/shoulder F of the teat T can fully or partially fit into the rebate 18 though in a preferred form the flange/shoulder F fits over the rebate 18 and contacts the surface of cover 11 as indicated in FIG. 6.

The opening 12 preferably includes an inclined surface 19 of the wall 20 that forms the transition between the cover 11 (or more particularly counter bore 18) and the top extremity of the screw-thread form 15. The inclined surface 19 encircles the top of the skirt 14.

Extending through this wall section 20 is one but preferably a plurality of apertures 21. These apertures 21 thus open into the interior of the cap 10 (as is apparent from the underside plan view of the cap 10 in FIG. 3 and the section view of FIG. 6) and hence the interior of the feeder bottle when the cap 10 is fitted to the bottle.

As can be more clearly seen from FIG. 6 the aperture 21 extends through the skirt 14 to an exit point 24 at the bottom of the skirt 14.

In the preferred form of the cap 10 as shown there are three apertures 21 but it will be appreciated by the skilled person that, the number of apertures can vary. For example only one aperture 21 could be used.

Formed in the cover 11 are one or more recesses 22 formed by a groove, channel, open topped slot or the like. For convenience the recess 22 will hereinafter be referred to as “slot 22”.

The slot 22 can take a form other than that shown in the drawings. to achieve the seal break as described herein.

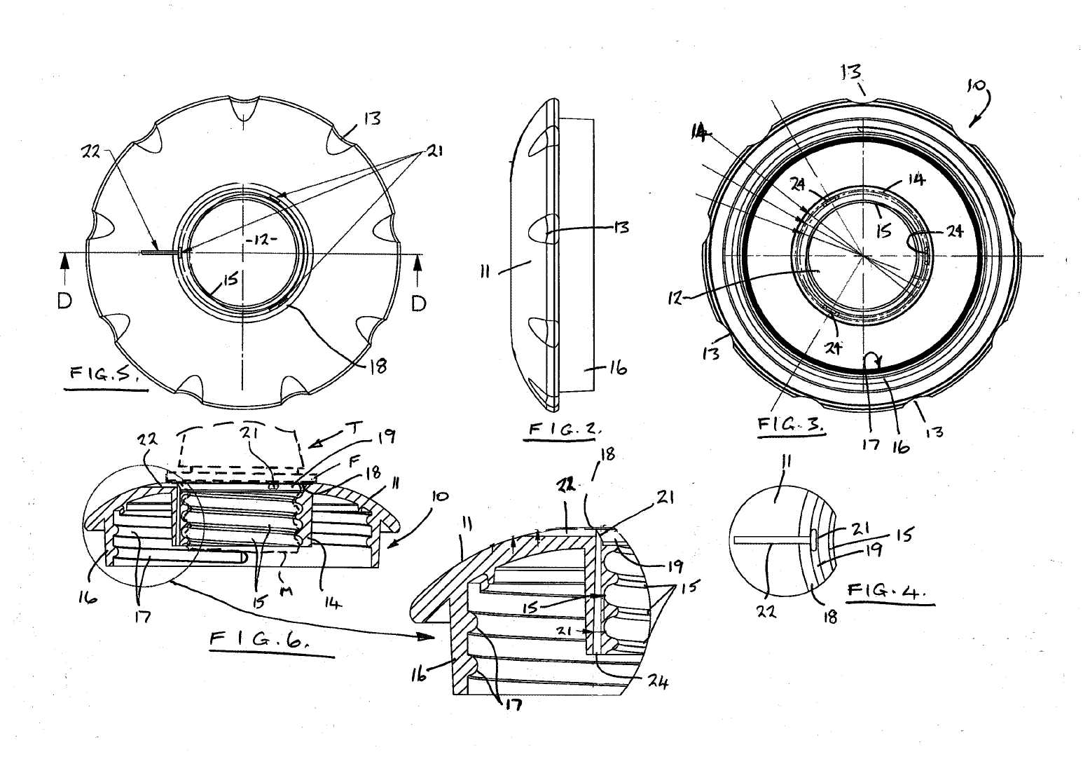

In the preferred form of the slot 22 the cross sectional shape will be angular as shown in FIG. 4 in particular.

In the construction shown in the drawings, the venting break is formed by one slot 22. The slot 22 extends from the floor of the rebate 18 from the, or one of the apertures 21.

In the preferred form of the invention only one slot 22 is provided. However, a slot 22 can extend from each aperture 21.

As shown, the slot 22 extends radially with reference to the rebate 18/central opening 12. The distance that the slot 22 extends is such that its distal end relative to the aperture 21 is beyond the flange/shoulder F when the teat T is fitted to the cap 10.

In use of the cap 10 a teat will be attached to the cap by the mounting end of the teat being inserted into the opening 12. In the particular cap 10 shown in the drawings the mounting end of the teat will have a screw thread that screws into the thread form 15 in the skirt 14.

The flange or shoulder of the teat (previously mentioned above) will thus engage with the cover 11 over the rebate/counter bore 18.

The slot(s) 22 form a break in the sealing interface between the teat T and the cover 11 and thereby form a small venting break.

The interior of the bottle to which the cap 10 is fitted can thus breathe through the aperture(s) 21 and the slot(s) 22. Surprisingly it has been found that it is possible to select a depth and shape of slot 22 that provides a venting gap yet a gap that is of a size such as to not allow the passage there through of liquid from the bottle in normal use of the bottle when feeding an animal. The slot 22 will also not be prone to blocking.

However, when the bottle is inverted (so the teat T is lowermost) a small quantity of liquid (feed) will flow through the slot over the flange/shoulder F and down the exterior surface of the teat. This has been found to be beneficial as the feed attracts the feeding animal to the teat. This is a particular advantage when training a young animal to feed from the teat.

The venting means of the invention is thus the combination of the aperture(s) 21 and the slot(s) 22 that “break” the seal between the cover 11 of cap 10 and the teat T to allow venting to occur but with substantially no leakage of fluid during actual feeding of the animal.

The present invention thus provides a simple yet very effective venting means and has particular application for an animal-feeding teat mounted by a cap to a feeder such as a bottle.

The invention is open to modification as will be appreciated by the skilled person. For example the number of apertures 21 and slot(s) 22 can vary and the number of slots 22 does not necessarily need to match the number of apertures 21. Also the venting means does not need to be part of a removable cap as described. The opening/teat mounting might be an integral part of a feeder rather than a removable part.

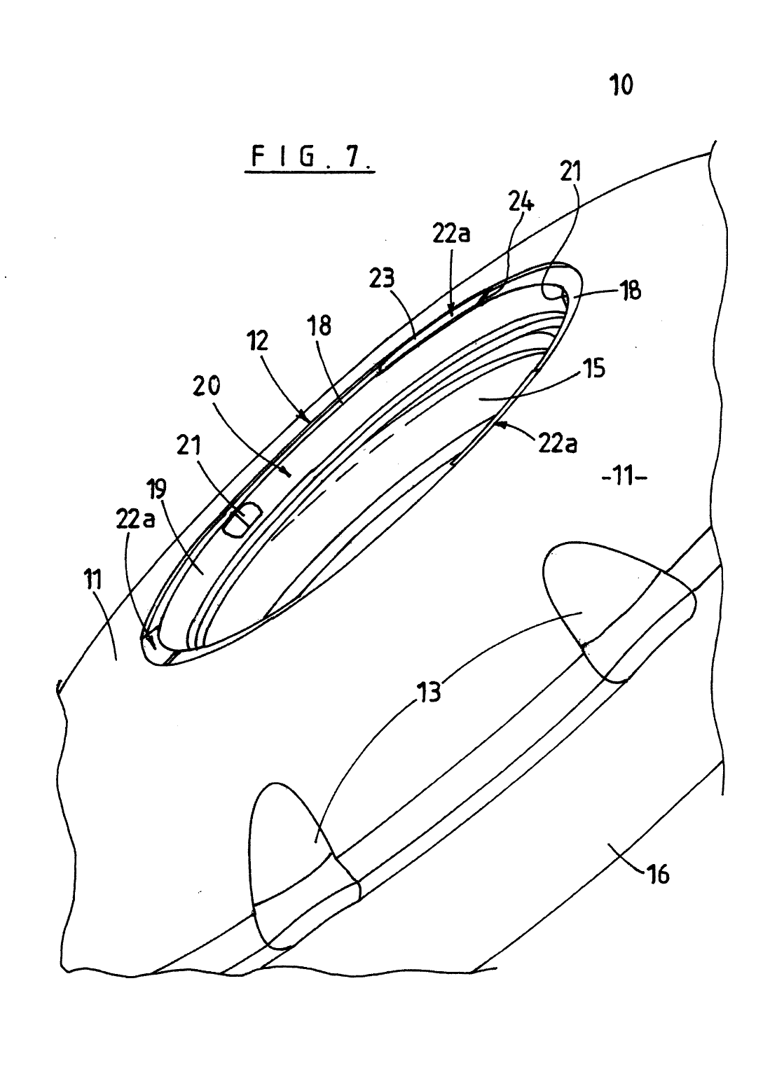

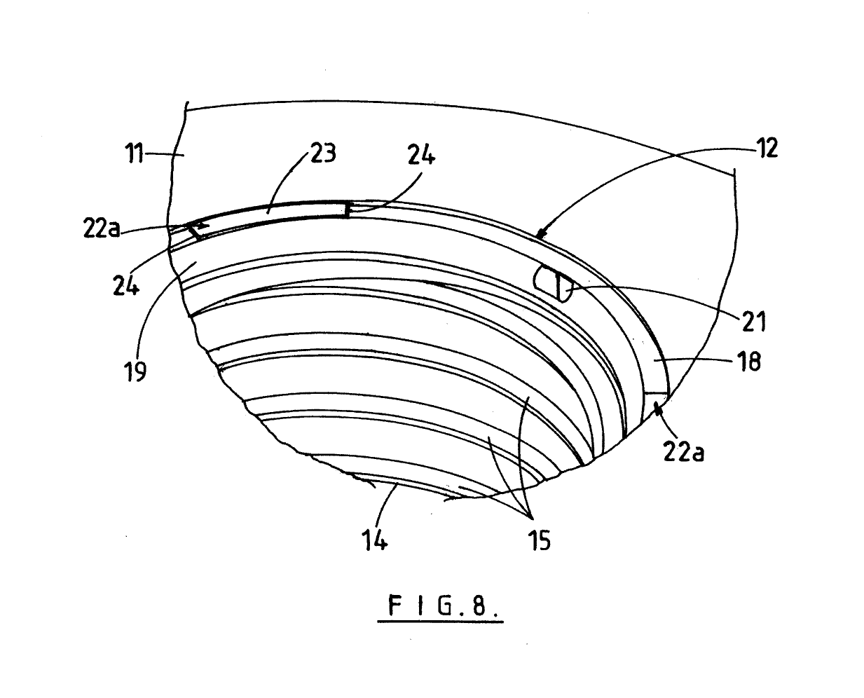

A further modification is shown in the second embodiment of the invention depicted in FIGS. 7 and 8. Elements of the design and construction of the venting means and the bottle cap in which it is incorporated have the same reference numerals as the first embodiment of FIGS. 1 to 6.

As can be seen in FIGS. 7 and 8 one or more protrusions 22a are located in the rebate/counterbore 18 and are formed by raised portions or pads. Each pad 22a preferably extends for substantially the width of the rebate 18. Also preferably the top surface 23 of the pad 22a lies just below the surface of the cover 11.

The protrusion 22a can take a form other than a pad of the general shape as shown in the drawings. For example the protrusion can be in the form of a ridge. Other shapes can be used to achieve the seal break as described herein.

In the preferred form of the pad 22a the ends 24 will be square as shown in FIGS. 7 and 8.

The number of pads 22a is preferably the same as the apertures 21. In the drawings each pad 22a is located equidistant between adjacent apertures 21. This is the preferred layout but in a moulding process it will be difficult to consistently achieve this layout. However, this will not adversely affect the working of the venting means even if the pads 22a are located immediately above the apertures 21.

The pads 22a are of low height. In the illustrated configuration of cap 10 the height of the pad 22a will be in the range of 0.10-0.30 mm but preferably will be 0.15 mm in height. In the preferred form the top surface 23 of the pad 22a will be about 0.10 mm below the surface of the cover 11.

These dimensions as given by way of example only. The dimensions can vary as will be appreciated by the skilled addressee. Achieving the break in the seal with substantially no leakage occurring will determine the actual shape and dimension of the protrusion. The term “pad” used herein is by way of example and is not limiting on the actual shape of the protrusion.

The flange or shoulder of the teat (previously mentioned above) will thus engage on the cover and the pads 22a when the teat is screwed fully into the opening 12. Because the pads 22a sit “proud” of the floor of the rebate/counter bore 18 the surface of the flange/shoulder can not seal flat against the floor of the counter bore 18 in the vicinity of the ends 24 of the pads. There is thus formed a small venting gap at each end of each pad 22a.

Similarly the apertures 21 form a break in the sealing surface and thereby form a small venting break.

The interior of the bottle to which the cap 10 is fitted can thus breath through the apertures 21 and the slight gap that will exist between the flange/shoulder of the teat and the floor of the counter bore 18 at the ends 24 of the pads 22. Surprisingly it has been found that it is possible to select a height of pad 22 (depth and shape of recess) that provides a venting gap yet a gap that is of a size such as to not allow the passage there through of liquid from the bottle in normal use of the bottle when feeding an animal.

The venting means of the invention is thus the combination of the apertures 21 and the protrusions 22a that “break” the seal between the cap and the teat to allow venting to occur but with substantially no leakage of fluid.

The present invention has been described and illustrated by way of a specific embodiment. It is not the intention of the Applicant to restrict or in any way limit the scope of the invention to such an embodiment. Modifications and changes within the inventive concept will be apparent to the skilled person.

Therefore, the invention in its broader aspects is not limited to the specific details, representative means of manufacture and method, and illustrative examples shown and described in this specification. Accordingly departures may be made from such details without departing from the spirit or scope of the Applicant's general inventive concept.

What is claimed is:

1. A venting arrangement for a feeding teat the venting means including an opening with which, in use, a mounting part of a feeding teat can engage in a substantially sealed manner, at least one aperture in the opening and at least one protrusion and/or recess that creates a break in the seal between the teat mounting part and a sealing surface of the opening whereby air can vent through said break and the aperture(s).

2. A arrangement as claimed in claim 1 wherein the at least one protrusion and/or at least one recess is/are located with the sealing surface.

3. A venting arrangement as claimed in claim 2 wherein there is a plurality of apertures.

4. A venting arrangement as claimed in claim 3 wherein a said recess is coupled to a single one of the apertures.

5. A venting arrangement as claimed in claim 1 wherein there is only a single aperture and an associated recess.

6. A venting arrangement as claimed in claim 1 wherein the at least one aperture is located in a rebate adjacent the opening.

7. A venting arrangement as claimed in claim 6 wherein a counter bore forms the rebate.

8. A venting arrangement as claimed in claim 1 wherein the recess is a slot, groove, channel or the like in the sealing surface and is connected to the aperture.

9. A venting arrangement as claimed in claim 8 wherein the dimensions of the recess is selected such as to provide a venting break in the seal between the mounting part of the teat and the opening yet without substantially any leakage of liquid feed through the venting break during feeding of an animal.

10. A venting arrangement as claimed in claim 9 wherein the recess is in the form of an open topped slot, channel or groove.

11. A venting arrangement as claimed in claim 1 wherein the at least one protrusion is located in a rebate or counterbore adjacent the opening.

12. A venting arrangement as claimed in claim 11 wherein the or each protrusion is of a height that is less than the depth of the rebate/counterbore.

13. A venting arrangement as claimed in claim 12 wherein the protrusions are offset from the apertures.

14. A venting arrangement as claimed in claim 12 wherein the protrusion is a pad or ridge of a height of substantially between 0.10 and 0.30 mm.

15. A feeder bottle which has an opening to which is removably fitted a closure, the closure has an opening in which a mounting part of an animal feeding teat and the closure includes a venting arrangement that includes an opening with which, in use, a mounting part of a feeding teat can engage in a substantially sealed manner, at least one aperture in the opening and at least one protrusion and/or recess that creates a break in the seal between the teat mounting part and a sealing surface of the opening whereby air can vent through said break and the aperture(s).

16. A feeder bottle as claimed in claim 15 wherein the closure is a cap.

17. A feeder bottle as claimed in claim 15 wherein the at least one recess is located with the sealing surface and is coupled to a single one of the apertures.

18. A feeder bottle as claimed in claim 17 wherein the recess is a slot, groove, channel or the like in the sealing surface and is connected to the aperture.

19. A feeder bottle as claimed in claim 18 wherein the dimensions of the recess is selected such as to provide a venting break in the seal between the mounting part of the teat and the opening yet without substantially any leakage of liquid feed through the venting break during feeding of an animal.

20. A feeder bottle as claimed in claim 19 wherein the at least one aperture is located in a rebate adjacent the opening and the rebate is formed by a counter bore.
